(19) United States
(12) Patent Application Publication
(10) Pub. No.: US 2004/0034528 A1
(43) Pub. Date: Feb. 19, 2004

(54) Server and receiving terminal

(75) Inventors: Keiichi Sakai, Kanagawa (JP); Tetsuo Kosaka, Yonezawa-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/455,443

(22) Filed: Jun. 6, 2003

(30) Foreign Application Priority Data
Jun. 12, 2002 (JP) 2002-171660 (PAT.

(51) Int. Cl. G10L 13/00

(52) U.S. Cl. 704/258

(57) ABSTRACT

A data communication unit (304) receives the resource information of an apparatus (101) from the apparatus (101). A voice synthesis execution determination unit (306) determines using the resource information of the apparatus (101) and the resource information of an apparatus (102) whether voice synthesis processing should be executed by the apparatus (101) or apparatus (102). When the voice synthesis execution determination unit (306) determines that the apparatus (102) should execute voice synthesis processing, a voice synthesizing unit (309) generates output voice data to read aloud a designated portion of a multimodal document. When the voice synthesis execution determination unit (306) determines that the apparatus (102) should execute voice synthesis processing, the data communication unit (304) transmits a voice synthesis result by the voice synthesizing unit (309) to the apparatus (101).

### FIELD OF THE INVENTION

The present invention relates to a server and receiving terminal.

### BACKGROUND OF THE INVENTION

Along with penetration of the Internet, the world of web-browsing is ever-growing in which documents that are described by a markup language (HTML: HyperText Markup Language) and held in servers connected to the Internet can be displayed on browsers on personal computers.

Because of the historical circumstances, an HTML document contains a portion that describes the structure of the document and a portion that describes the transcription. CSS (Cascading Style Sheet) that extracts a transcription from a structure is also widely used.

Even when CSS (transcription) is separated from HTML (structure+transcription), the document structure of HTML takes the transcription into consideration. Hence, a method of describing a document using XML (eXtensible Markup Language) which expresses only the tree structure of the contents of the document and XSL (extensible Style sheet Language) which converts the tree into an object to be expressed is also spreading.

FIGS. 10 and 11 show document examples described using XML and XSL, respectively. FIGS. 12, 13, and 14 show examples of an HTML document and CSS file generated by XML and XSL and a display example on a browser.

As described above, various style sheets such as CSS and XML are prepared and appropriately switched. Accordingly, a single XML document that expresses only the tree structure of the contents of a document can be switched in accordance with the application purpose.

On the other hand, mobile terminals such as cellular phones, PHSs (Personal Handyphone Systems), and PDAs (Personal Data Assistants), which users daily carry, are attaining higher performance. The processing capability of high-end mobile terminals compares advantageously with that of personal computers of the preceding generation.

Such a high-end mobile terminal has the following characteristic features.

(1) The terminal can be connected to a host computer through a public line or wireless LAN and perform data communication with the host computer.

(2) Many of such terminals have a voice input/output device (e.g., a microphone and loudspeaker).

However, the high-end mobile terminal generally has a small display window for displaying GUI, so the GUI display capability is low. In addition, there are not only high-end mobile terminals but also many mobile terminals that are not on the high-end of the market. Some of these low-end mobile terminals cannot display GUI information.

Under these circumstances around mobile terminals, it is significant to implement a multimodal interface that allows to execute some or all of operations and responses using voice.

In handling multimodal documents, some of high-end mobile terminals can recognize and synthesize voice, though many mobile terminals cannot it at all or can only poorly recognize and synthesize voice.

Generally, voice synthesis requires no resources such as a CPU and memory, unlike voice recognition. However, only a limited number of mobile terminals now have a voice synthesis function. In addition, although voice recognition required in a mobile terminal is accepted to be speaker-dependent at a high probability, voice synthesis is preferably able to selectively use a plurality of speaker's voice tones if possible. That is, schemes that need relatively many resources are required, including expressive speech that realizes expression of feeling and is expected to develop in the future. Even for a host computer serving as a server, the load of voice synthesis becomes large if a number of mobile terminals serve as clients. Hence, the load is preferably as small as possible.

Furthermore, from the viewpoint of communication data capacity, it is more effective to transmit a text to a mobile terminal serving as a client and synthesize voice there rather than to transmit voice synthesized in a host computer serving as a server.

The present invention has been made in consideration of the above problems, and has as its object to reduce the load of the entire system by determining an apparatus that should execute voice synthesis processing in consideration of the processing load of all apparatuses. It is another object of the present invention to reduce the load of the entire system by determining an apparatus that should execute voice recognition processing in consideration of the processing load of all apparatuses.

### SUMMARY OF THE INVENTION

According to the present invention, the forgoing object is attained by providing an information processing apparatus which transmits document data to an external apparatus, comprising: resource reception means for receiving resource information of the external apparatus; determination means for determining using the resource information of the external apparatus and resource information of the information processing apparatus whether voice synthesis processing should be executed by the external apparatus or the information processing apparatus; voice synthesis means for, when the determination means determines that the information processing apparatus should execute voice synthesis processing, generating output voice data to read aloud the document data; and transmission means for, when the determination means determines that the information processing apparatus should execute voice synthesis processing, transmitting a voice synthesis processing result by the voice synthesis means to the external apparatus.

According to another aspect of the present invention, the forgoing object is attained by providing an information processing apparatus which transmits document data to an external apparatus, comprising: resource reception means for receiving resource information of the external apparatus; voice data reception means for receiving voice data from the external apparatus; determination means for determining using the resource information of the external apparatus and resource information of the information processing apparatus whether voice recognition processing should be executed by the external apparatus or the information processing apparatus; voice recognition means for, when the determination means determines that the information processing apparatus should execute voice recognition processing, executing voice recognition on the basis of the voice data; and transmission means for, when the determination means determines that the information processing apparatus should execute voice recognition processing, transmitting a voice recognition processing result by the voice recognition means to the external apparatus.

According to still another aspect of the present invention, the forgoing object is attained by providing an information processing apparatus which transmits document data to an external apparatus, comprising: resource reception means for receiving resource information of the external apparatus; voice data reception means for receiving voice data from the external apparatus; determination means for determining using the resource information of the external apparatus and the resource information of the information processing apparatus whether voice synthesis processing and/or voice recognition processing should be executed by the external apparatus or the information processing apparatus; voice synthesis means for, when the determination means determines that the information processing apparatus should execute voice synthesis processing, generating output voice data to read aloud the document data; voice recognition means for, when the determination means determines that the information processing apparatus should execute voice recognition processing, executing voice recognition on the basis of the voice data; voice synthesis result transmission means for, when the determination means determines that the information processing apparatus should execute voice synthesis processing, transmitting a voice synthesis processing result by the voice synthesis means to the external apparatus; and voice recognition result transmission means for, when the determination means determines that the information processing apparatus should execute voice recognition processing, transmitting a voice recognition processing result by the voice recognition means to the external apparatus.

According to still another aspect of the present invention, the forgoing object is attained by providing a control method of an information processing apparatus which transmits document data to an external apparatus, comprising: a resource reception step of receiving resource information of the external apparatus; a determination step of determining using the resource information of the external apparatus and resource information of the information processing apparatus whether voice synthesis processing should be executed by the external apparatus or the information processing apparatus; a voice synthesis step of, when it is determined in the determination step that the information processing apparatus should execute voice synthesis processing, generating output voice data to read aloud the document data; and a transmission step of, when it is determined in the determination step that the information processing apparatus should execute voice synthesis processing, transmitting a voice synthesis processing result in the voice synthesis step to the external apparatus.

According to still another aspect of the present invention, the forgoing object is attained by providing a control method of an information processing apparatus which transmits document data to an external apparatus, comprising: a resource reception step of receiving resource information of the external apparatus; a voice data reception step of receiving voice data from the external apparatus; a determination step of determining using the resource information of the external apparatus and resource information of the information processing apparatus whether voice recognition processing should be executed by the external apparatus or the information processing apparatus; a voice recognition step of, when it is determined in the determination step that the information processing apparatus should execute voice recognition processing, executing voice recognition on the basis of the voice data; and a transmission step of, when it is determined in the determination step that the information processing apparatus should execute voice recognition processing, transmitting a voice recognition processing result in the voice recognition step to the external apparatus.

According to still another aspect of the present invention, the forgoing object is attained by providing a control method of an information processing apparatus which transmits document data to an external apparatus, comprising: a resource reception step of receiving resource information of the external apparatus; a voice data reception step of receiving voice data from the external apparatus; a determination step of determining using the resource information of the external apparatus and the resource information of the information processing apparatus whether voice synthesis processing and/or voice recognition processing should be executed by the external apparatus or the information processing apparatus; a voice synthesis step of, when it is determined in the determination step that the information processing apparatus should execute voice synthesis processing, generating output voice data to read aloud the document data; a voice recognition step of, when it is determined in the determination step that the information processing apparatus should execute voice recognition processing, executing voice recognition on the basis of the voice data; a voice synthesis result transmission step of, when it is determined in the determination step that the information processing apparatus should execute voice synthesis processing, transmitting a voice synthesis processing result in the voice synthesis step to the external apparatus; and a voice recognition result transmission step of, when it is determined in the determination step that the information processing apparatus should execute voice recognition processing, transmitting a voice recognition processing result in the voice recognition step to the external apparatus.

According to still another aspect of the present invention, the forgoing object is attained by providing an information processing apparatus which receives document data from an external apparatus and reads aloud the document data, comprising: first reception means for, when a synthesis execution determination result by the external apparatus, which represents whether voice synthesis processing should be executed by the information processing apparatus or the external apparatus, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus; second reception means for receiving data representing the synthesis execution determination result from the external apparatus; voice synthesis means for, when the synthesis execution determination result indicates that the information processing apparatus should execute voice synthesis processing, generating output voice data to read aloud the document data received by the first reception means; and voice output means for reading aloud the document data received by the first reception means using one of output voice data obtained by decoding the encoded output voice data received by the first reception means and the output voice data generated by the voice synthesis means.

According to still another aspect of the present invention, the forgoing object is attained by providing an information processing apparatus which is connected to an external apparatus through a network and can execute data communication with the external apparatus, comprising: input means for inputting voice data as a GUI input; recognition execution determination result data reception means for receiving, from the external apparatus, data representing a recognition execution determination result that indicates whether voice recognition processing of the voice data should be executed by the information processing apparatus or the external apparatus; voice recognition means for, when the recognition execution determination result indicates that the information processing apparatus should execute voice recognition processing, executing voice recognition for the voice data input from the input means; and encoded voice data transmission means for, when the recognition execution determination result indicates that the external apparatus should execute voice recognition processing, encoding the voice data input from the input means and transmitting the encoded voice data to the external apparatus.

According to still another aspect of the present invention, the forgoing object is attained by providing an information processing apparatus which receives document data from an external apparatus and reads aloud the document data, comprising: reception means for, when a synthesis execution determination result by the external apparatus, which represents whether voice synthesis processing should be executed by the information processing apparatus or the external apparatus, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus; synthesis execution determination result data reception means for receiving data representing the synthesis execution determination result; input means for inputting voice data as a GUI input; recognition execution determination result data reception means for receiving, from the external apparatus, data representing a recognition execution determination result that indicates whether voice recognition processing of the voice data should be executed by the information processing apparatus or the external apparatus; voice synthesis means for, when the synthesis execution determination result indicates that the information processing apparatus should execute voice synthesis processing, generating output voice data to read aloud the document data received by the reception means; voice output means for reading aloud the document data received by the reception means using one of output voice data obtained by decoding the encoded output voice data received by the reception means and the output voice data generated by the voice synthesis means; voice recognition means for, when the recognition execution determination result indicates that the information processing apparatus should execute voice recognition processing, executing voice recognition for the voice data input from the input means; and encoded voice data transmission means for, when the recognition execution determination result indicates that the external apparatus should execute voice recognition processing, encoding the voice data input from the input means and transmitting the encoded voice data to the external apparatus.

According to still another aspect of the present invention, the forgoing object is attained by providing a control method of an information processing apparatus which receives document data from an external apparatus and reads aloud the document data, comprising: a first reception step of, when a synthesis execution determination result by the external apparatus, which represents whether voice synthesis processing should be executed by the information processing apparatus or the external apparatus, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus; a second reception step of receiving data representing the synthesis execution determination result from the external apparatus; a voice synthesis step of, when the synthesis execution determination result indicates that the information processing apparatus should execute voice synthesis processing, generating output voice data to read aloud the document data received in the first reception step; and a voice output step of reading aloud the document data received in the first reception step using one of output voice data obtained by decoding the encoded output voice data received in the first reception step and the output voice data generated in the voice synthesis step.

According to still another aspect of the present invention, the forgoing object is attained by providing a control method of an information processing apparatus which is connected to an external apparatus through a network and can execute data communication with the external apparatus, comprising: an input step of inputting voice data as a GUI input; a recognition execution determination result data reception step of receiving, from the external apparatus, data representing a recognition execution determination result that indicates whether voice recognition processing of the voice data should be executed by the information processing apparatus or the external apparatus; a voice recognition step of, when the recognition execution determination result indicates that the information processing apparatus should execute voice recognition processing, executing voice recognition for the voice data input in the input step; and an encoded voice data transmission step of, when the recognition execution determination result indicates that the external apparatus should execute voice recognition processing, encoding the voice data input in the input step and transmitting the encoded voice data to the external apparatus.

According to still another aspect of the present invention, the forgoing object is attained by providing a control method of an information processing apparatus which receives document data from an external apparatus and reads aloud the document data, comprising: a reception step of, when a synthesis execution determination result by the external apparatus, which represents whether voice synthesis processing should be executed by the information processing apparatus or the external apparatus, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus; a synthesis execution determination result data reception step of receiving data representing the synthesis execution determination result; an input step of inputting voice data as a GUI input; a recognition execution determination result data reception step of receiving, from the external apparatus, data representing a recognition execution determination result that indicates whether voice recognition processing of the voice data should be executed by the information processing apparatus or the external apparatus; a voice synthesis step of, when the synthesis execution determination result indicates that the information processing apparatus should execute voice synthesis processing, generating output voice data to read aloud the document data received in the reception step; a voice output step of reading aloud the document data received in the reception step using one of output voice data obtained by decoding the encoded output voice data received in the reception step and the output voice data generated in the voice synthesis step; a voice recognition step of, when the recognition execution determination result indicates that the information processing apparatus should execute voice recognition processing, executing voice recognition for the voice data input in the input step; and an encoded voice data transmission step of, when the recognition execution determination result indicates that the external apparatus should execute voice recognition processing, encoding the voice data input in the input step and transmitting the encoded voice data to the external apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the arrangement of a communication system according to the present invention;

FIG. 2 is a block diagram showing the basic arrangement of a multimodal document reception processing apparatus according to the first embodiment of the present invention;

FIG. 3 is a block diagram showing the basic arrangement of a multimodal document editing/transmission apparatus according to the first embodiment of the present invention;

FIG. 4 is a flow chart of processing executed by the multimodal document reception processing apparatus;

FIG. 5 is a flow chart of processing executed by the multimodal document editing/transmission apparatus;

FIG. 6 is a view showing an example of a multimodal document transmitted from the multimodal document editing/transmission apparatus;

FIG. 7 is a view showing a display example when the multimodal document shown in FIG. 6 is displayed on a GUI display unit 211;

FIG. 8 is a view showing an example of an original document before editing:

FIG. 9 is a view showing an example of a style sheet to be applied to the original document shown in FIG. 8;

FIG. 10 is a view showing an example of a document described using XML;

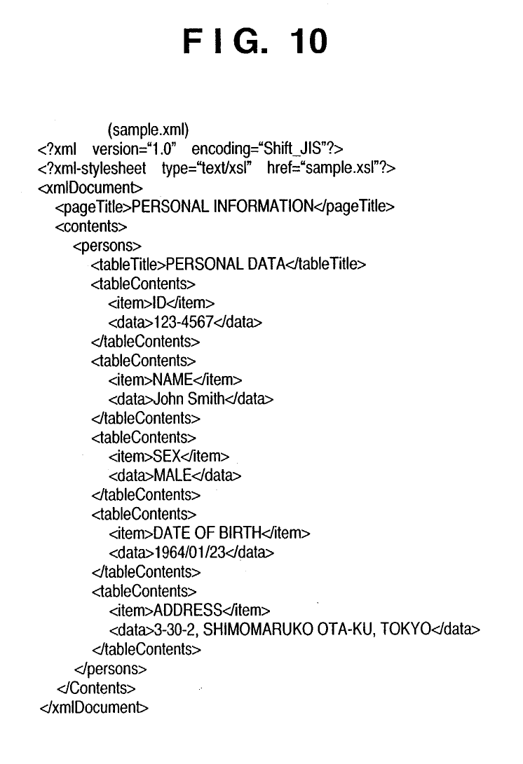

FIG. 11 is a view showing an example of a document described using XSL;

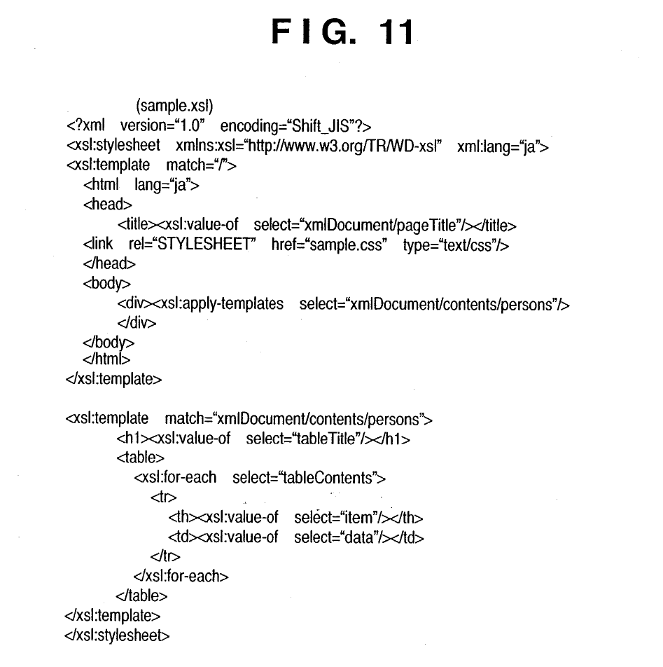

FIG. 12 is a view showing an HTML document generated using XML and XSL;

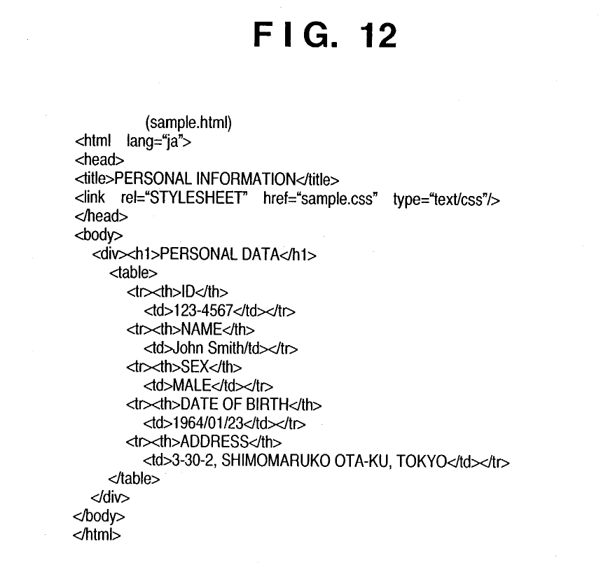

FIG. 13 is a view showing an example of a CSS file in the HTML document shown in FIG. 12;

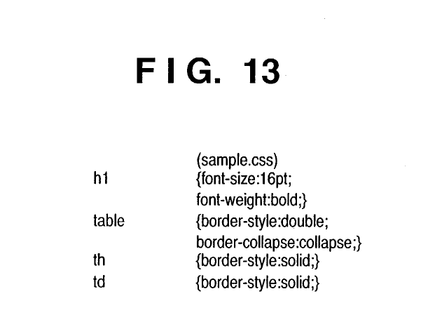

FIG. 14 is a view showing a display example of the HTML document shown in FIG. 12, which is displayed on a browser;

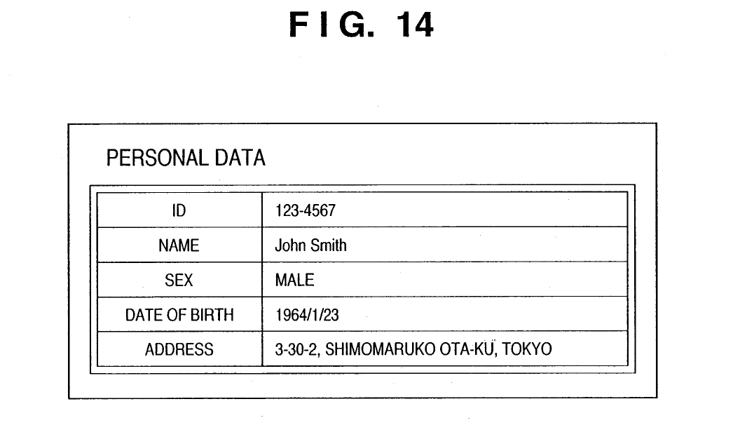

FIG. 15 is a block diagram showing the basic arrangement of a multimodal document reception processing apparatus according to the fifth embodiment of the present invention;

FIG. 16 is a block diagram showing the basic arrangement of a multimodal document editing/transmission apparatus according to the fifth embodiment of the present invention;

FIG. 17 is a flow chart of processing executed by the multimodal document reception processing apparatus; and

FIG. 18 is a flow chart of processing executed by the multimodal document editing/transmission apparatus.

### DETAILED DESCRIPTION OF THE PREFERRED EMBODIMENTS

Preferred embodiments of the present invention will now be described in detail in accordance with the accompanying drawings.

[First Embodiment]

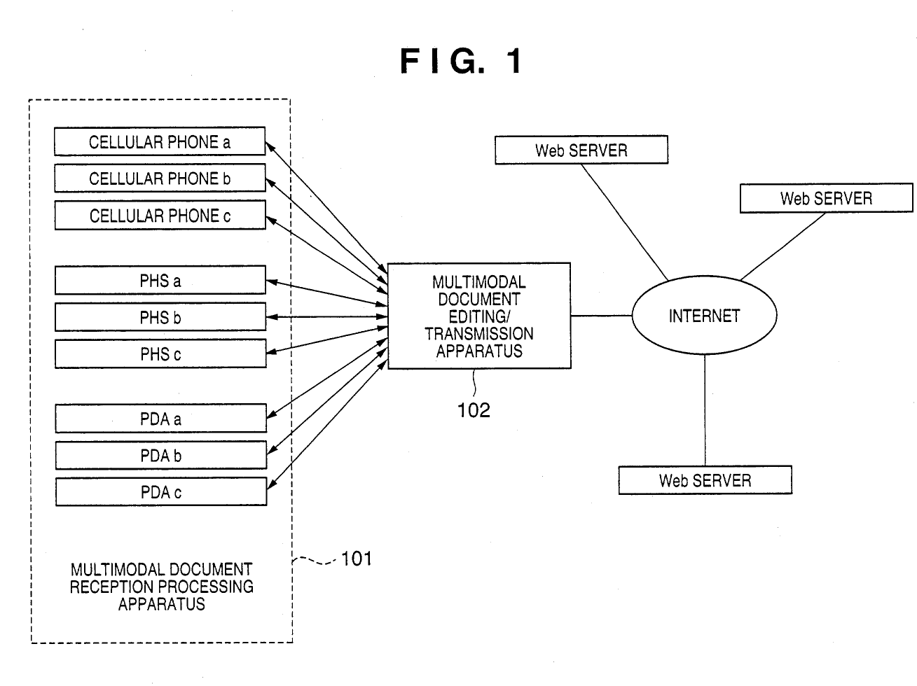

FIG. 1 shows the arrangement of a communication system according to this embodiment. An information receiving terminal 101 comprises mobile terminals such as cellular phones, PHSs, or PDAs. These mobile terminals are generally called multimodal document reception processing apparatuses. Each device may sometimes be called a multimodal document reception processing apparatus. A multimodal document editing/transmission apparatus 102 communicates with the multimodal document reception processing apparatus 101 and also acquires an original document from an external Web server.

A multimodal text indicates text data that can be input using a plurality of input means such as a keyboard, mouse, and voice.

The multimodal document reception processing apparatus 101 and multimodal document editing/transmission apparatus 102 can execute data communication through a communication means such as a public line or wireless LAN.

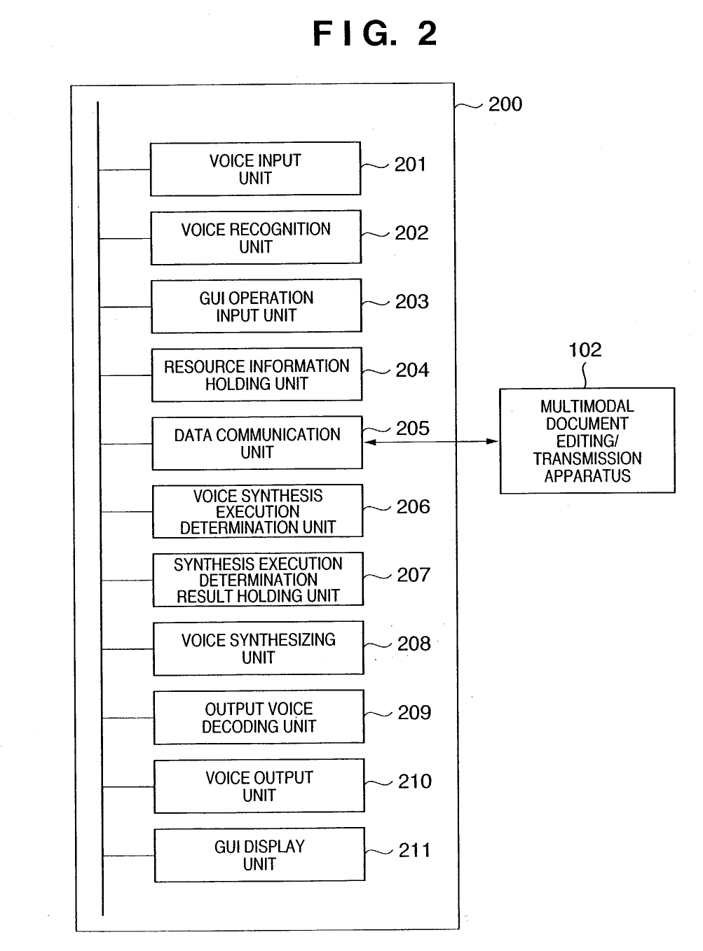

FIG. 2 is a block diagram showing the basic arrangement of the multimodal document reception processing apparatus. Referring to FIG. 2, a multimodal document reception processing apparatus main body 200 includes units to be described below. A voice input unit 201 is constituted by, e.g., a microphone with which the user inputs voice. A voice recognition unit 202 recognizes voice input from the voice input unit 201. The recognition result is processed like a character input by GUI input.

A GUI operation input unit 203 performs various operation inputs (GUI operations) by a pointing device such as a stylus or buttons such as a ten-key pad. A resource information holding unit 204 holds resource information that represents the CPU speed of the multimodal document reception processing apparatus.

A data communication unit 205 transmits the GUI operation input from the GUI operation input unit and resource information held by the resource information holding unit to the multimodal document editing/transmission apparatus 102, and receives data representing a voice synthesis execution determination result, multimodal document data, and encoded output voice data from the multimodal document editing/transmission apparatus 102.

A voice synthesis execution determination unit 206 determines on the basis of the voice synthesis execution determination result received by the data communication unit 205 whether voice synthesis is to be executed by the multimodal document reception processing apparatus 101. A synthesis execution determination holding unit 207 holds the synthesis execution determination by the voice synthesis execution determination unit 206.

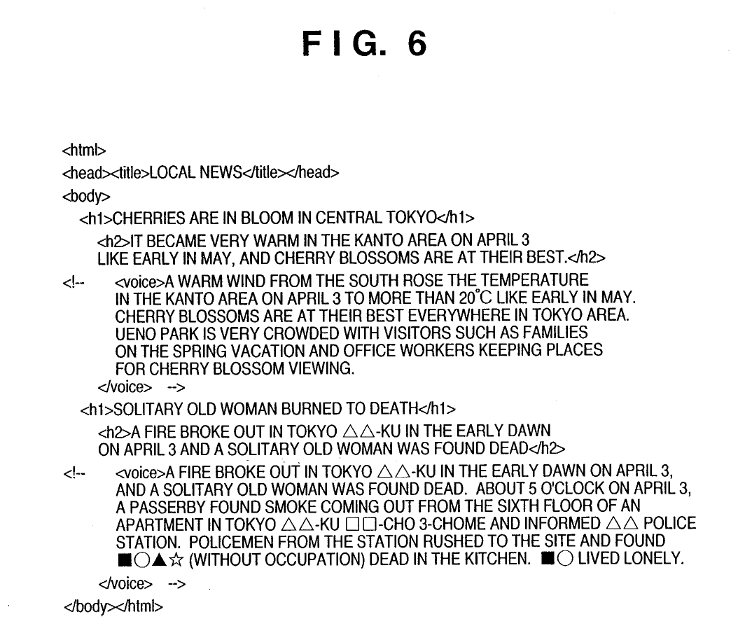

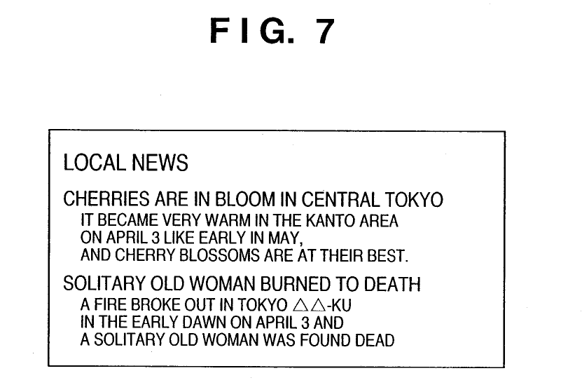

When the voice synthesis execution determination unit 206 determines that voice synthesis should be executed in the multimodal document reception processing apparatus 101, a voice synthesizing unit 208 executes processing (voice synthesis processing) of generating data of output voice which reads aloud a text portion to be output as voice in the multimodal document received by the data communication unit 205. Assume that the text portion to be output as voice is designated in advance. FIG. 6 shows an example of a multimodal document transmitted from the multimodal document editing/transmission apparatus 102. Referring to FIG. 6, the text of a portion sandwiched between “<voice>” tags corresponds to the text portion to be subjected to voice synthesis. FIG. 7 shows a display window when the multimodal document shown in FIG. 6 is displayed on a GUI display unit 211.

When the text corresponding to the portion sandwiched between the “<voice>” tags is pointed by the GUI input on the display window shown in FIG. 7, synthesized voice that reads aloud the text portion is output from a voice output unit 210.

When the voice synthesis execution determination unit 206 determines that voice synthesis should not be executed in the multimodal document reception processing apparatus 101, an output voice decoding unit 209 decodes the encoded output voice data received by the data communication unit 205. Decoding here means decoding of output voice that is quantized for digital communication. An example of decoded voice data is a voice file having, e.g., a WAV format.

The voice output unit 210 is constituted by a loudspeaker or earphone. The voice output unit 210 outputs output voice generated by the voice synthesizing unit 208 or output voice decoded by the output voice decoding unit 209. The GUI display unit 211 is constituted by, e.g., a Web browser which displays the GUI display contents of the multimodal document received by the data communication unit 205. Since the above-described units are connected through buses, they can transmit/receive data to/from each other.

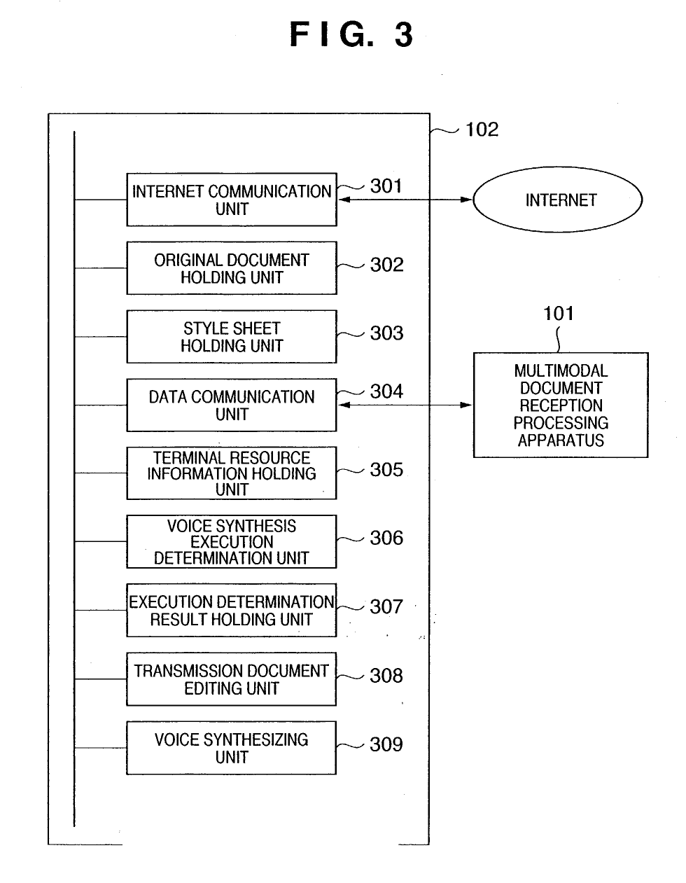

FIG. 3 is a block diagram showing the basic arrangement of the multimodal document editing/transmission apparatus 102 according to this embodiment. Referring to FIG. 3, an Internet communication unit 301 acquires, from an external Web server through the Internet, the original document of a multimodal document that should be edited and transmitted to the multimodal document reception processing apparatus 101. An original document holding unit 302 holds the document acquired by the Internet communication unit 301.

A style sheet holding unit 303 holds style sheets to be used to edit the original document held by the original document holding unit 302. A data communication unit 304 receives a GUI operation input and resource information from the multimodal document reception processing apparatus 101 and transmits data representing a voice synthesis execution determination result (to be described later), multimodal document data, and encoded output voice data to the multimodal document reception processing apparatus 101.

A terminal resource information holding unit 305 holds the resource information received by the data communication unit 304 in correspondence with each multimodal document reception processing apparatus 101. The terminal resource information holding unit 305 specifies the multimodal document reception processing apparatus 101 on the basis of a telephone number when the apparatus is connected through a public line or an IP address when the apparatus is connected through a wireless LAN, and holds the resource information of each terminal in association with the telephone number or IP address.

On the basis of the resource information of the terminal under communication, which is held by the terminal resource information holding unit 305, and the resource information of the multimodal document editing/transmission apparatus 102 (in this embodiment, the load average of the multimodal document editing/transmission apparatus 102), a voice synthesis execution determination unit 306 determines whether voice synthesis should be executed in the multimodal document editing/transmission apparatus 102.

An execution determination result holding unit 307 holds data representing the result of determination by the voice synthesis execution determination unit 306. A transmission document editing unit 308 edits the multimodal document by applying a style sheet held by the style sheet holding unit 303 to the original document held by the original document holding unit 302. When the voice synthesis execution determination unit 306 determines that multimodal document editing/transmission apparatus 102 should execute voice synthesis, a voice synthesizing unit 309 executes voice synthesis processing for a text portion to be output as voice in the multimodal document.

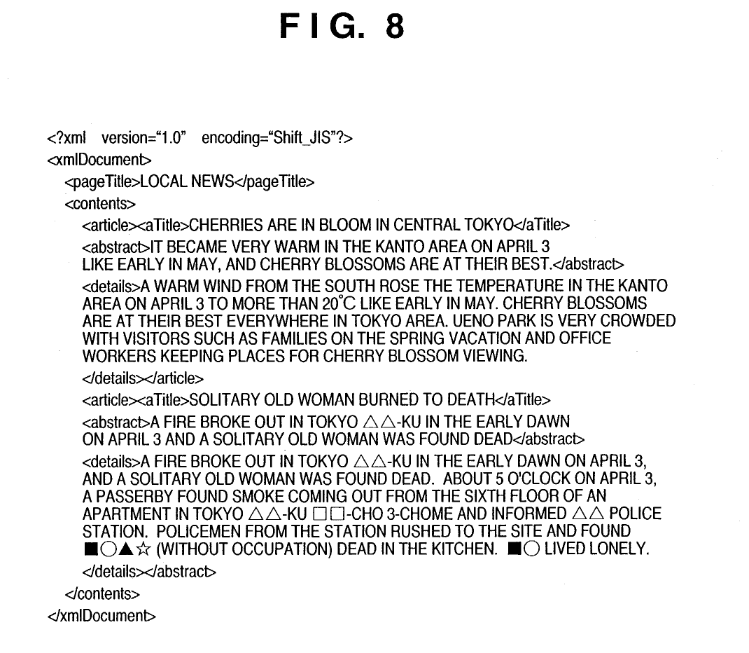

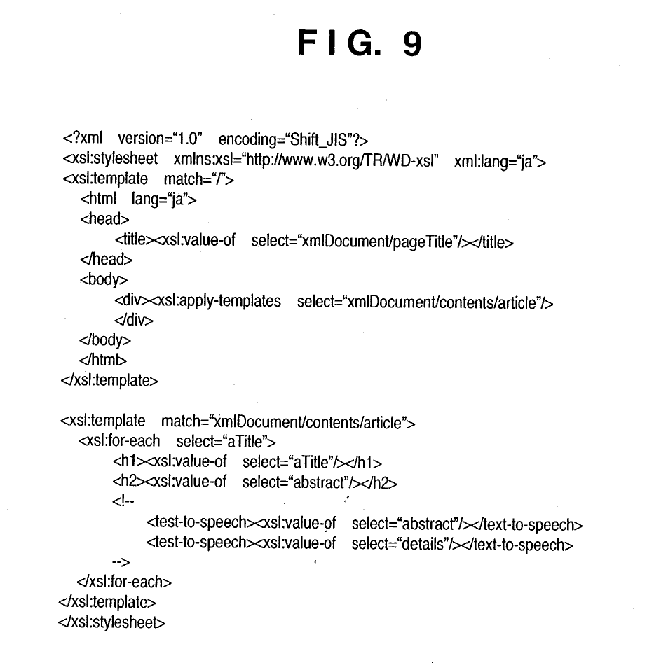

FIG. 8 shows an example of an original document before editing. FIG. 9 shows an example of a style sheet to be applied to the original document shown in FIG. 8. When the style sheet shown in FIG. 9 is applied to the original document shown in FIG. 8, the multimodal document shown in FIG. 6 can be generated.

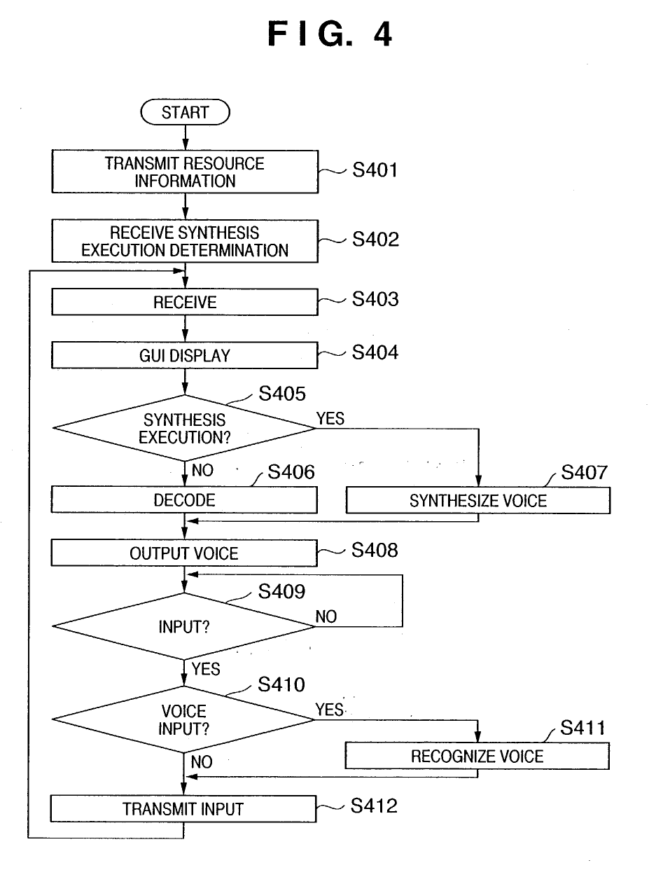

FIG. 4 is a flow chart of processing executed by the multimodal document reception processing apparatus 101. First, the data communication unit 205 transmits resource information that represents the CPU speed of the multimodal document reception processing apparatus, which is held by the resource information holding unit 204, to the multimodal document editing/transmission apparatus 102 (step S401). The data communication unit 205 receives, from the multimodal document editing/transmission apparatus 102, data that indicates synthesis execution determination (in the server) (to be described later) representing whether voice synthesis should be executed in the server. The synthesis execution determination holding unit 207 holds the received data that represents the synthesis execution determination (step S402). Next, the data communication unit 205 receives only multimodal document data or multimodal document data and encoded output voice data from the multimodal document editing/transmission apparatus 102 (step S403). The GUI display unit 211 displays (GUI-displays) a window according to the received multimodal document data (step S404).

Next, the voice synthesis execution determination unit 206 refers to the data that indicates the synthesis execution determination, which is held by the synthesis execution determination holding unit 207, and determines whether the multimodal document reception processing apparatus 101 should execute voice synthesis processing (step S405). When the multimodal document reception processing apparatus 101 should execute voice synthesis processing, the processing advances to step S407. The voice synthesizing unit 208 executes voice synthesis processing for a text portion to be output as voice in the multimodal document to generate output voice data (step S407).

When the multimodal document reception processing apparatus 101 should not execute voice synthesis, the processing advances to step S406. The output voice decoding unit 209 decodes the encoded output voice data received by the data communication unit 205 to reconstruct the output voice data (step S406). The voice output unit 210 outputs voice according to the output voice data by the voice synthesizing unit 208 or the output voice data by the output voice decoding unit 209 (step S408).

When a user input (user input from the voice input unit 201 or GUI operation input unit 203) is received (step S409), the processing advances to step S410. When voice is input from the voice input unit 201 (step S410), the processing advance to step S411. The voice recognition unit 202 recognizes the voice input through the voice input unit 201 and defines it as GUI operation (step S411). The data communication unit 205 transmits the GUI operation from the voice input unit 201 or the GUI operation from the GUI operation input unit 203 to the multimodal document editing/transmission apparatus 102 (step S412).

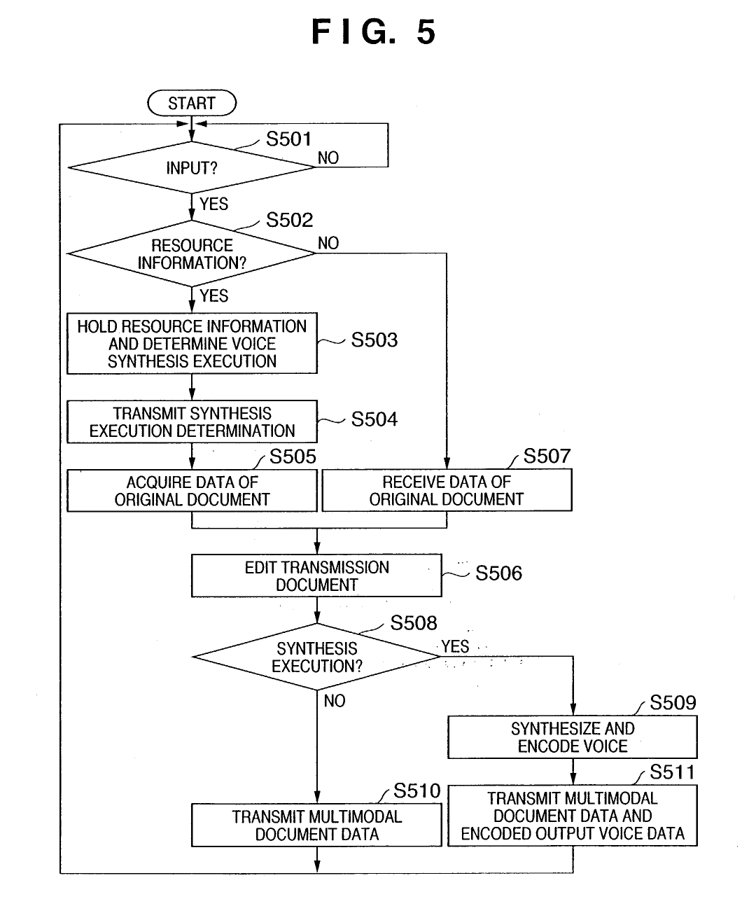

FIG. 5 is a flow chart of processing executed by the multimodal document editing/transmission apparatus 102. The data communication unit 304 basically waits for an input from the multimodal document reception processing apparatus. Upon receiving an input, the data communication unit 304 executes the following processing.

When an input from the multimodal document reception processing apparatus is received (step S501), the processing advances to step S502. When the input from the multimodal document reception processing apparatus is resource information (step S502), the processing advances to step S503. The voice synthesis execution determination unit 306 causes the terminal resource information holding unit 305 to hold the resource information together with the telephone number or IP address of the multimodal document reception processing apparatus 101 and also executes voice synthesis execution determination processing of determining whether the multimodal document editing/transmission apparatus 102 should execute voice synthesis (step S503).

In this embodiment, as a voice synthesis execution determination method, a value obtained by subtracting the load average from 1 is multiplied by the CPU speed of the multimodal document editing/transmission apparatus 102, and the product is compared with the CPU speed of the multimodal document reception processing apparatus. When the CPU speed of the multimodal document reception processing apparatus is higher, it is determined that voice synthesis processing should not be executed in the multimodal document editing/transmission apparatus 102. When the CPU speed of the multimodal document reception processing apparatus is lower, it is determined that voice synthesis processing should be executed in the multimodal document editing/transmission apparatus 102. As described above, data representing this determination result, i.e., data representing synthesis execution determination is held by the execution determination result holding unit 307.

Next, the data communication unit 304 transmits the data representing the synthesis determination by the voice synthesis execution determination unit 306 in step S503 to the multimodal document reception processing apparatus 101 (step S504). The Internet communication unit 301 acquires the data (homepage data) of the original document through the Internet and holds the data in the original document holding unit 302 (step S505).

On the other hand, if it is determined in step S502 that the input from the multimodal document reception processing apparatus is GUI operation, the processing advances to step S507. The Internet communication unit 301 acquires the data of the original document (the data of a homepage that is linked to the homepage that is currently being browsed) corresponding to the GUI operation from another Web server through the Internet and holds the data in the original document holding unit 302 (step S507).

Next, the transmission document editing unit 308 executes transmission document editing processing of applying a style sheet held by the style sheet holding unit 303 to the page data held by the original document holding unit 302 (step S506). The voice synthesizing unit 309 refers to the data representing the synthesis execution determination, which is held by the execution determination result holding unit 307. If voice synthesis processing is to be executed (step S508), the processing advances to step S509. The voice synthesizing unit 309 executes voice synthesis for the text portion to be voice-synthesized in the multimodal document edited by the transmission document editing unit 308 to generate output voice data, and also executes encoding processing for the output voice data for data communication, thereby generating encoded output voice data (step S509). The data communication unit 304 transmits the multimodal document data and encoded output voice data to the multimodal document reception processing apparatus 101 (step S511).

On the other hand, when voice synthesis processing is not to be executed, the processing advances to step S510. The data communication unit 304 transmits the multimodal document data edited by the transmission document editing unit 308 to the multimodal document reception processing apparatus 101 (step S510).

As described above, first, the multimodal document reception processing apparatus 101 transmits the resource information of its own to the multimodal document editing/transmission apparatus 102. The multimodal document editing/transmission apparatus 102 determines on the basis of its processing capability whether voice synthesis should be executed in the multimodal document reception processing apparatus 101 or multimodal document editing/transmission apparatus 102 and transmits the determination result to the multimodal document reception processing apparatus 101. The multimodal document reception processing apparatus 101 determines on the basis of the determination result returned from the multimodal document editing/transmission apparatus 102 whether voice synthesis should be executed in the multimodal document reception processing apparatus 101. Accordingly, since an apparatus with a smaller processing load executes voice synthesis processing, the processing load of the entire system can be reduced.

[Second Embodiment]

In the first embodiment, for the descriptive convenience, the product obtained by multiplying the CPU speed of the multimodal document editing/transmission apparatus 102 by a value obtained by subtracting the load average from 1 is simply compared with the CPU speed of the multimodal document reception processing apparatus 101 in the voice synthesis execution determination processing by the multimodal document editing/transmission apparatus 102. However, comparison with weight may be executed in consideration of the fact that transmission/reception to/from a plurality of multimodal document editing/transmission apparatuses 102 is executed or can be executed.

[Third Embodiment]

In the first embodiment, only the CPU speed is used as resource information. However, the present invention is not limited to this. Any other information such as a memory capacity representing the processing performance of the multimodal document reception processing apparatus can be used.

[Fourth Embodiment]

In the first embodiment, the voice synthesis execution determination processing by the multimodal document editing/transmission apparatus 102 is executed only once at the start of session. This processing may be executed, for example, every time transmission/reception is performed or at a predetermined time interval using a timer.

[Fifth Embodiment]

In the above embodiment, on the basis of the CPU speed of the multimodal document reception processing apparatus and the load average of the multimodal document editing/transmission apparatus 102, the multimodal document editing/transmission apparatus 102 executes determination processing to determine which apparatus should execute voice synthesis processing. A multimodal document editing/transmission apparatus 102 according to the fifth embodiment executes determination processing to determine which apparatus should execute voice recognition processing. Processing except this is the same as in the first embodiment.

More specifically, in a communication system according to this embodiment, voice synthesis processing is always executed by a multimodal document reception apparatus. Processing of determining which apparatus should execute processing of recognizing voice input from the user as a GUI input is executed. The arrangement of the communication system according to this embodiment is the same as that of the first embodiment (the arrangement shown in FIG. 1).

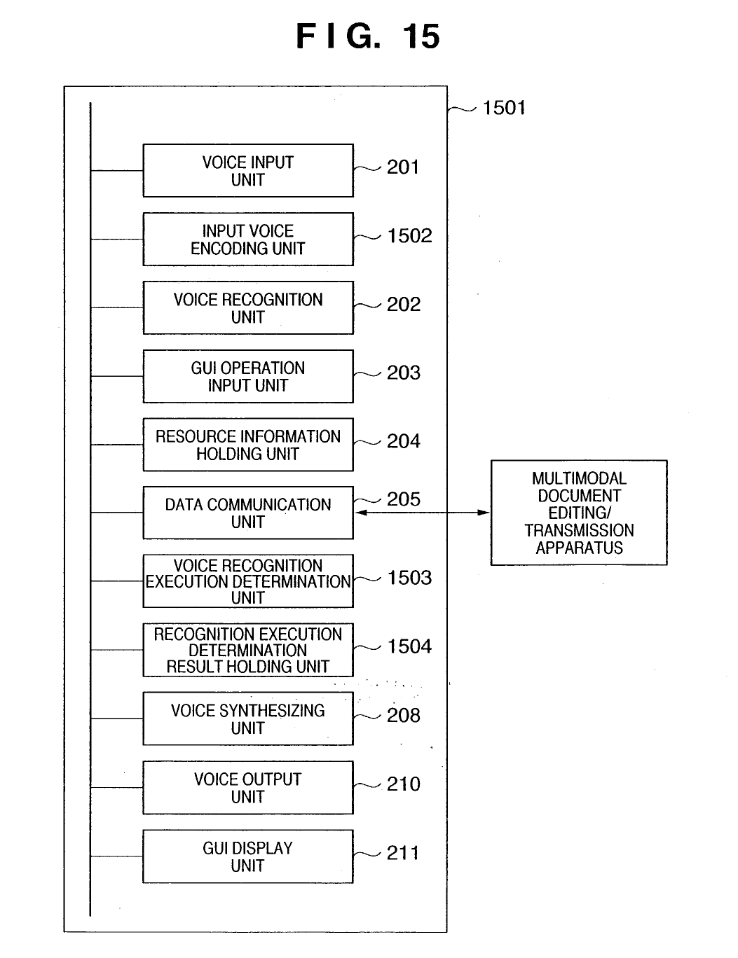

FIG. 15 shows the basic arrangement of a multimodal document reception processing apparatus according to this embodiment. The same reference numerals as in FIG. 2 denote the same parts in FIG. 15, and a description thereof will be omitted. Reference numeral 1501 denotes a multimodal document reception processing apparatus main body according to this embodiment. An input voice encoding unit 1502 encodes voice input from a voice input unit 201 to reduce the size of voice data. A voice recognition execution determination unit 1503 determines on the basis of a voice recognition execution determination result received by a data communication unit 205 whether voice recognition should be executed in the multimodal document reception processing apparatus. A recognition execution determination result holding unit 1504 holds the recognition execution determination by the voice recognition execution determination unit 1503.

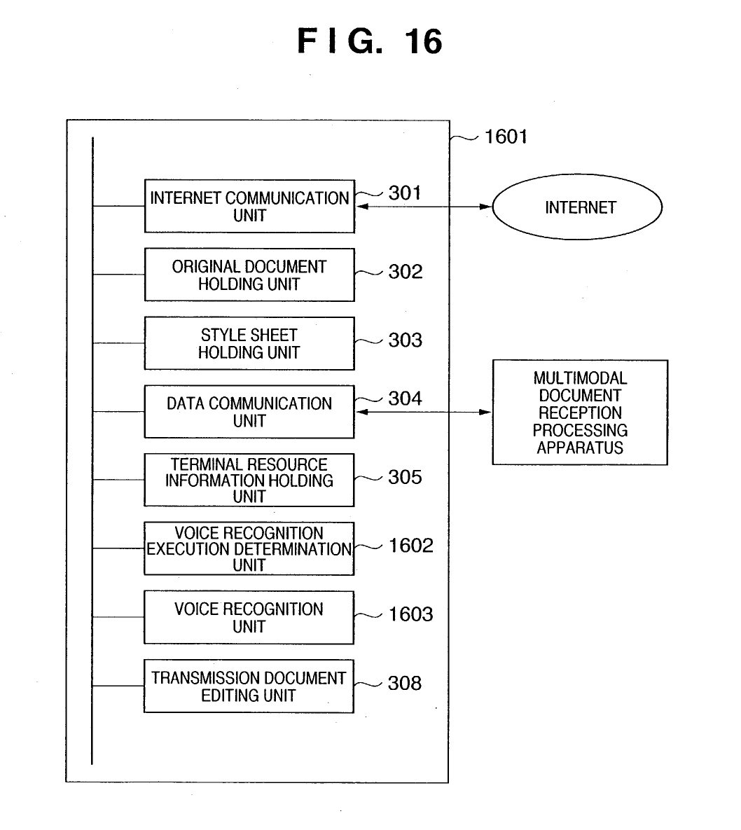

FIG. 16 shows the basic arrangement of a multimodal document editing/transmission apparatus according to this embodiment. The same reference numerals as in FIG. 3 denote the same parts in FIG. 16, and a description thereof will be omitted. Reference numeral 1601 denotes a multimodal document editing/transmission apparatus main body according to this embodiment. On the basis of the resource information of the terminal that is currently communicating, which is held by a terminal resource information holding unit 305, and the load average of the multimodal document editing/transmission apparatus, a voice recognition execution determination unit 1602 determines whether voice recognition should be executed in the multimodal document editing/transmission apparatus. When the voice recognition execution determination unit 1602 determines that voice recognition should be executed, a voice recognition unit 1603 executes voice recognition.

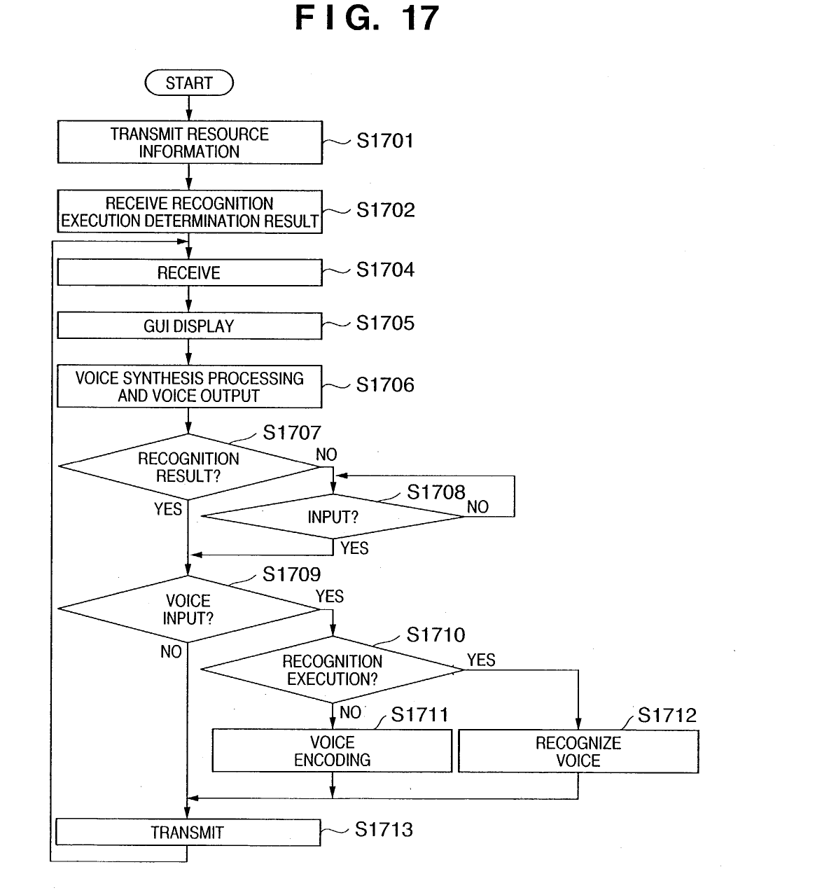

FIG. 17 is a flow chart of processing executed by the multimodal document reception processing apparatus according to this embodiment. The data communication unit 205 transmits resource information that represents the CPU speed, which is held by a resource information holding unit 204, to the multimodal document editing/transmission apparatus (step S1701). Next, the data communication unit 205 receives from the multimodal document editing/transmission apparatus recognition execution determination (to be described later) that represents whether voice recognition is to be executed in the server. The recognition execution determination result holding unit 1504 holds data representing the recognition execution determination result (step S1702).

The data communication unit 205 receives only multimodal document data or a set of multimodal document and a voice recognition result from the multimodal document editing/transmission apparatus (step S1704). More specifically, when the multimodal document editing/transmission apparatus should not execute voice recognition, the data communication unit 205 receives only the multimodal document data. When the multimodal document editing/transmission apparatus should execute voice recognition, the data communication unit 205 receives the set of multimodal document data and voice recognition result.

A GUI display unit 211 displays (GUI-displays) a window corresponding to the received multimodal document data or, if a voice recognition result is received, a window corresponding to the voice recognition result (step S1705). In addition, a voice synthesizing unit 208 executes voice synthesis processing of generating voice data that reads aloud a text portion to be voice-synthesized in the multimodal document data received by the data communication unit 205. A voice output unit 210 outputs the generated voice data as voice (step S1706).

Next, a user input (input from one of the voice input unit 201 and a GUI operation input unit 203) is detected (step S1707, S1708). When the input is a voice input from the voice input unit 201 (step S1709), the processing advances to step S1710. The voice recognition execution determination unit 1503 refers to the data representing the recognition execution determination, which is held by the recognition execution determination result holding unit 1504, and determines whether the multimodal document reception processing apparatus should execute voice recognition processing (step S1710).

When the voice recognition execution determination unit 1503 determines that the multimodal document reception processing apparatus should execute voice recognition processing, the processing advances to step S1712. A voice recognition unit 202 executes voice recognition processing for the voice input from the voice input unit 201 (step S1712). A technique related to the voice recognition processing is known, and a detailed description thereof will be omitted. The voice recognition processing result is input to the multimodal document editing/transmission apparatus as a GUI input.

When the multimodal document reception processing apparatus should not execute voice recognition processing, the processing advances to step S1711. The input voice encoding unit 1502 encodes the voice input from the voice input unit 201 (step S1711). The data communication unit 205 transmits the voice encoded data to the multimodal document editing/transmission apparatus (step S1713).

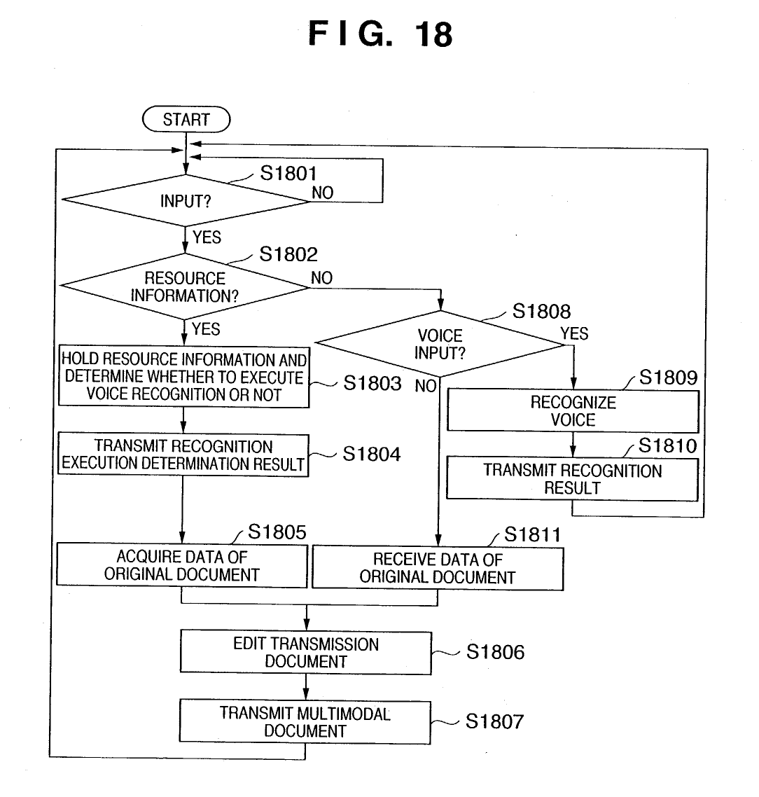

FIG. 18 is a flow chart of processing executed by the multimodal document editing/transmission apparatus according to this embodiment. A data communication unit 304 basically waits for an input from the multimodal document reception processing apparatus. Upon receiving an input, the data communication unit 304 executes the following processing.

When an input from the multimodal document reception processing apparatus is received (step S1801), the processing advances to step S1802. When the input from the multimodal document reception processing apparatus is resource information (step S1802), the processing advances to step S1803. The voice recognition execution determination unit 1602 causes a terminal resource information holding unit 305 to hold the resource information together with the telephone number or IP address of the multimodal document reception processing apparatus and also executes voice recognition execution determination processing of determining whether the multimodal document editing/transmission apparatus should execute voice recognition (step S1803).

In this embodiment, as a voice recognition execution determination method, a value obtained by subtracting the load average from 1 is multiplied by the CPU speed of the multimodal document editing/transmission apparatus, and the product is compared with the CPU speed of the multimodal document reception processing apparatus. When the CPU speed of the multimodal document reception processing apparatus is higher, it is determined that voice recognition processing should not be executed in the multimodal document editing/transmission apparatus. When the CPU speed of the multimodal document reception processing apparatus is lower, it is determined that voice recognition processing should be executed in the multimodal document editing/transmission apparatus. The data communication unit 304 transmits data representing the voice recognition determination result to the multimodal document reception processing apparatus (step S1804).

An Internet communication unit 301 acquires the data (homepage data) of the original document through the Internet and holds the data in an original document holding unit 302 (step S1805).

On the other hand, if it is determined in step S1802 that the input from the multimodal document reception processing apparatus is not resource information, the processing advances to step S1808. When the input is a voice input (input of voice encoded data) (step S1808), the processing advances to step S1809. The voice recognition unit 1603 decodes the voice encoded data received by the data communication unit 304 and executes voice recognition processing for the restored voice data (step S1809) The voice recognition result is transmitted from the data communication unit 304 to the multimodal document reception processing apparatus (step S1810).

On the other hand, when the input received by the data communication unit 304 in step S1808 is a GUI input (step S1808), the processing advances to step S1811. The data of the original document (the data of a homepage that is linked to the homepage that is currently being browsed) corresponding to the GUI input is acquired and held in the original document holding unit 302 (step S1811).

Next, a transmission document editing unit 308 executes transmission document editing processing of applying a style sheet held by a style sheet holding unit 303 to the page data held by the original document holding unit 302 to generate multimodal document data (step S1806). The data communication unit 304 transmits the multimodal document to the multimodal document reception processing apparatus (step S1807).

As described above, first, the multimodal document reception processing apparatus transmits the resource information of its own to the multimodal document editing/transmission apparatus. The multimodal document editing/transmission apparatus determines on the basis of its processing capability whether voice recognition should be executed in the multimodal document reception processing apparatus or multimodal document editing/transmission apparatus and transmits the determination result to the multimodal document reception processing apparatus. The multimodal document reception processing apparatus determines on the basis of the determination result transmitted from the multimodal document editing/transmission apparatus whether voice recognition should be executed in the multimodal document reception processing apparatus. Accordingly, since an apparatus with a smaller processing load executes voice recognition processing, the processing load of the entire system can be reduced.

[Sixth Embodiment]

In the fifth embodiment, for the descriptive convenience, the product obtained by multiplying the CPU speed of the multimodal document editing/transmission apparatus by a value obtained by subtracting the load average from 1 is simply compared with the CPU speed of the multimodal document reception processing apparatus in the voice synthesis execution determination processing by the multimodal document editing/transmission apparatus. However, comparison with weight may be executed in consideration of the fact that transmission/reception to/from a plurality of multimodal document editing/transmission apparatuses is executed or can be executed.

[Seventh Embodiment]

In the fifth embodiment, only the CPU speed is used as resource information. However, the present invention is not limited to this. Any other information such as a memory capacity representing the processing performance of the multimodal document reception processing apparatus can be used.

[Eighth Embodiment]

In the fifth embodiment, when the multimodal document editing/transmission apparatus determines in consideration of its processing capability that voice recognition should not be executed in the multimodal document reception processing apparatus, no voice recognition is executed. However, voice recognition may also be executed in the multimodal document reception processing apparatus, and one of the two recognition results may be employed on the basis of the recognition speed or likelihood.

[Ninth Embodiment]

In the fifth embodiment, the voice recognition execution determination processing by the multimodal document editing/transmission apparatus is executed only once at the start of session. However, re-evaluation may be executed, for example, every time transmission/reception is performed or at a predetermined time interval using a timer.

[10th Embodiment]

In the above embodiments, the multimodal document editing/transmission apparatus refers to resource information received from the multimodal document reception processing apparatus and executes determination processing of determining which apparatus should execute voice synthesis processing or voice recognition processing. However, both determination processing operations may be executed. More specifically, the multimodal document editing/transmission apparatus refers to resource information received from the multimodal document reception processing apparatus and executes the determination processing, and as a consequence, it may be determined that voice synthesis processing should be executed by the multimodal document reception processing apparatus, and voice recognition processing should be executed by the multimodal document editing/transmission apparatus.

[Other Embodiment]

In the above embodiments, a four-color printer of CMYK has been described as an image output apparatus. However, the object of the present invention can also be achieved by a color printer having another arrangement.

The object of the present invention can also be achieved by supplying a storage medium which stores software program codes for implementing the functions of the above-described embodiments to a system or apparatus and causing the computer (or a CPU or MPU) of the system or apparatus to read out and execute the program codes stored in the storage medium.

In this case, the program codes read out from the storage medium implement the functions of the above-described embodiments by themselves, and the storage medium which stores the program codes constitutes the present invention.

As the storage medium for supplying the program codes, for example, a floppy disk (registered trademark), hard disk, optical disk, magnetooptical disk, CD-ROM, CD-R, nonvolatile memory card, ROM, or the like can be used. The functions of the above-described embodiments are implemented not only when the readout program codes are executed by the computer but also when the OS (Operating System) running on the computer performs part or all of actual processing on the basis of the instructions of the program codes.

The functions of the above-described embodiments are also implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

As has been described above, according to the present invention, an apparatus which should execute voice synthesis processing can be determined in consideration of the processing load of all the apparatuses, and the load of the entire system can be reduced. In addition, according to the present invention, an apparatus which should execute voice recognition processing can be determined in consideration of the processing load of all the apparatuses, and the load of the entire system can be reduced.

As many apparently widely different embodiments of the present invention can be made without departing from the spirit and scope thereof, it is to be understood that the invention is not limited to the specific embodiments thereof except as defined in the appended claims.

What is claimed is:

1. An information processing apparatus which transmits document data to an external apparatus, comprising:
resource reception means for receiving resource information of the external apparatus;
determination means for determining, using the resource information of the external apparatus and resource information of the information processing apparatus, whether the external apparatus or the information processing apparatus should execute voice synthesis processing;
voice synthesis means for, when said determination means determines that the information processing apparatus should execute voice synthesis processing, generating output voice data to read aloud the document data; and
transmission means for, when said determination means determines that the information processing apparatus should execute voice synthesis processing, transmitting a voice synthesis processing result by said voice synthesis means to the external apparatus.

2. An information processing apparatus which transmits document data to an external apparatus, comprising:
resource reception means for receiving resource information of the external apparatus;
voice data reception means for receiving voice data from the external apparatus;
determination means for determining, using the resource information of the external apparatus and resource information of the information processing apparatus, whether the external apparatus or the information processing apparatus should execute voice recognition processing;
voice recognition means for, when said determination means determines that the information processing apparatus should execute voice recognition processing, executing voice recognition on the basis of the voice data; and
transmission means for, when said determination means determines that the information processing apparatus should execute voice recognition processing, transmitting a voice recognition processing result by said voice recognition means to the external apparatus.

3. An information processing apparatus which transmits document data to an external apparatus, comprising:
resource reception means for receiving resource information of the external apparatus;
voice data reception means for receiving voice data from the external apparatus;
determination means for determining, using the resource information of the external apparatus and the resource information of the information processing apparatus, whether the external apparatus or the information processing apparatus should execute voice synthesis processing and/or voice recognition processing;
voice synthesis means for, when said determination means determines that the information processing apparatus should execute voice synthesis processing, generating output voice data to read aloud the document data;
voice recognition means for, when said determination means determines that the information processing apparatus should execute voice recognition processing, executing voice recognition on the basis of the voice data;
voice synthesis result transmission means for, when said determination means determines that the information processing apparatus should execute voice synthesis processing, transmitting a voice synthesis processing result by said voice synthesis means to the external apparatus; and
voice recognition result transmission means for, when said determination means determines that the information processing apparatus should execute voice recognition processing, transmitting a voice recognition processing result by said voice recognition means to the external apparatus.

4. The apparatus according to claim 1, wherein said determination means compares a value obtained by multiplying a CPU speed of the information processing apparatus by a value obtained by subtracting a load average from 1 with a CPU speed of the external apparatus, when the CPU speed of the external apparatus is higher, determines that voice synthesis processing by the information processing apparatus should not be executed, and when the CPU speed of the external apparatus is lower, determines that voice synthesis processing by the information processing apparatus should be executed.

5. The apparatus according to claim 2, wherein said determination means compares a value obtained by multiplying a CPU speed of the information processing apparatus by a value obtained by subtracting a load average from 1 with a CPU speed of the external apparatus, when the CPU speed of the external apparatus is higher, determines that voice recognition processing by the information processing apparatus should not be executed, and when the CPU speed of the external apparatus is lower, determines that voice recognition processing by the information processing apparatus should be executed.

6. The apparatus according to claim 1, wherein said voice synthesis means generates the output voice data to read aloud a portion sandwiched between predetermined tags in the document data.

7. The apparatus according to claim 2, wherein said voice recognition means executes voice recognition on the basis of the voice data input as a GUI input.

8. A control method of an information processing apparatus which transmits document data to an external apparatus, comprising:
a resource reception step of receiving resource information of the external apparatus;
a determination step of determining, using the resource information of the external apparatus and resource information of the information processing apparatus, whether the external apparatus or the information processing apparatus should execute voice synthesis processing;
a voice synthesis step of, when it is determined in the determination step that the information processing apparatus should execute voice synthesis processing, generating output voice data to read aloud the document data; and
a transmission step of, when it is determined in the determination step that the information processing apparatus should execute voice synthesis processing, transmitting a voice synthesis processing result in the voice synthesis step to the external apparatus.

9. A control method of an information processing apparatus which transmits document data to an external apparatus, comprising:
a resource reception step of receiving resource information of the external apparatus;
a voice data reception step of receiving voice data from the external apparatus;
a determination step of determining, using the resource information of the external apparatus and resource information of the information processing apparatus, whether the external apparatus or the information processing apparatus should execute voice recognition processing;
a voice recognition step of, when it is determined in the determination step that the information processing apparatus should execute voice recognition processing, executing voice recognition on the basis of the voice data; and
a transmission step of, when it is determined in the determination step that the information processing apparatus should execute voice recognition processing, transmitting a voice recognition processing result in the voice recognition step to the external apparatus.

10. A control method of an information processing apparatus which transmits document data to an external apparatus, comprising:
a resource reception step of receiving resource information of the external apparatus;
a voice data reception step of receiving voice data from the external apparatus;
a determination step of determining, using the resource information of the external apparatus and the resource information of the information processing apparatus, whether the external apparatus or the information processing apparatus should execute voice synthesis processing and/or voice recognition processing;
a voice synthesis step of, when it is determined in the determination step that the information processing apparatus should execute voice synthesis processing, generating output voice data to read aloud the document data;
a voice recognition step of, when it is determined in the determination step that the information processing apparatus should execute voice recognition processing, executing voice recognition on the basis of the voice data;
a voice synthesis result transmission step of, when it is determined in the determination step that the information processing apparatus should execute voice synthesis processing, transmitting a voice synthesis processing result in the voice synthesis step to the external apparatus; and
a voice recognition result transmission step of, when it is determined in the determination step that the information processing apparatus should execute voice recognition processing, transmitting a voice recognition processing result in the voice recognition step to the external apparatus.

11. An information processing apparatus which receives document data from an external apparatus and reads aloud the document data, comprising:
first reception means for, when a synthesis execution determination result by the external apparatus, which represents whether the information processing apparatus or the external apparatus should execute voice synthesis processing, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus;
second reception means for receiving data representing the synthesis execution determination result from the external apparatus;
voice synthesis means for, when the synthesis execution determination result indicates that the information processing apparatus should execute voice synthesis processing, generating output voice data to read aloud the document data received by said first reception means; and
voice output means for reading aloud the document data received by said first reception means using one of output voice data obtained by decoding the encoded output voice data received by said first reception means and the output voice data generated by said voice synthesis means.

12. An information processing apparatus which is connected to an external apparatus through a network and can execute data communication with the external apparatus, comprising:
input means for inputting voice data as a GUI input;
recognition execution determination result data reception means for receiving, from the external apparatus, data representing a recognition execution determination result that indicates whether the information processing apparatus or the external apparatus should execute voice recognition processing of the voice data;
voice recognition means for, when the recognition execution determination result indicates that the information processing apparatus should execute voice recognition processing, executing voice recognition for the voice data input from said input means; and
encoded voice data transmission means for, when the recognition execution determination result indicates that the external apparatus should execute voice recognition processing, encoding the voice data input from said input means and transmitting the encoded voice data to the external apparatus.

13. An information processing apparatus which receives document data from an external apparatus and reads aloud the document data, comprising:
reception means for, when a synthesis execution determination result by the external apparatus, which represents whether the information processing apparatus or the external apparatus should execute voice synthesis processing, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus;
synthesis execution determination result data reception means for receiving data representing the synthesis execution determination result;
input means for inputting voice data as a GUI input;
recognition execution determination result data reception means for receiving, from the external apparatus, data representing a recognition execution determination result that indicates whether the information processing apparatus or the external apparatus should execute voice recognition processing of the voice data;
voice synthesis means for, when the synthesis execution determination result indicates that the information processing apparatus should execute voice synthesis processing, generating output voice data to read aloud the document data received by said reception means;
voice output means for reading aloud the document data received by said reception means using one of output voice data obtained by decoding the encoded output voice data received by said reception means and the output voice data generated by said voice synthesis means;
voice recognition means for, when the recognition execution determination result indicates that the information processing apparatus should execute voice recognition processing, executing voice recognition for the voice data input from said input means; and
encoded voice data transmission means for, when the recognition execution determination result indicates that the external apparatus should execute voice recognition processing, encoding the voice data input from said input means and transmitting the encoded voice data to the external apparatus.

14. The apparatus according to claim 11, further comprising resource information transmission means for transmitting resource information to the external apparatus.

15. The apparatus according to claim 11, wherein said first reception means receives data representing a synthesis execution determination result based on resource information.

16. The apparatus according to claim 12, wherein said recognition execution determination result data reception means receives data representing a synthesis execution determination result based on resource information.

17. The apparatus according to claim 13, wherein said synthesis execution determination result data reception means receives data representing a synthesis execution determination result based on resource information.

18. The apparatus according to claim 11, wherein said voice synthesis means generates the output voice data to read aloud a portion sandwiched between predetermined tags in the document data.

19. A control method of an information processing apparatus which receives document data from an external apparatus and reads aloud the document data, comprising:
a first reception step of, when a synthesis execution determination result by the external apparatus, which represents whether the information processing apparatus or the external apparatus should execute voice synthesis processing, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus;
a second reception step of receiving data representing the synthesis execution determination result from the external apparatus;
a voice synthesis step of, when the synthesis execution determination result indicates that the information processing apparatus should execute voice synthesis processing, generating output voice data to read aloud the document data received in the first reception step; and
a voice output step of reading aloud the document data received in the first reception step using one of output voice data obtained by decoding the encoded output voice data received in the first reception step and the output voice data generated in the voice synthesis step.

20. A control method of an information processing apparatus which is connected to an external apparatus through a network and can execute data communication with the external apparatus, comprising:
an input step of inputting voice data as a GUI input;
a recognition execution determination result data reception step of receiving, from the external apparatus, data representing a recognition execution determination result that indicates whether the information processing apparatus or the external apparatus should execute voice recognition processing of the voice data;
a voice recognition step of, when the recognition execution determination result indicates that the information processing apparatus should execute voice recognition processing, executing voice recognition for the voice data input in the input step; and
an encoded voice data transmission step of, when the recognition execution determination result indicates that the external apparatus should execute voice recognition processing, encoding the voice data input in the input step and transmitting the encoded voice data to the external apparatus.

21. A control method of an information processing apparatus which receives document data from an external apparatus and reads aloud the document data, comprising:
a reception step of, when a synthesis execution determination result by the external apparatus, which represents whether the information processing apparatus or the external apparatus should execute voice synthesis processing, indicates that the information processing apparatus should execute voice synthesis processing, receiving the document data from the external apparatus, and when the synthesis execution determination result indicates that the external apparatus should execute voice synthesis processing, receiving the document data and encoded output voice data from the external apparatus;
a synthesis execution determination result data reception step of receiving data representing the synthesis execution determination result;
an input step of inputting voice data as a GUI input;
a recognition execution determination result data reception step of receiving, from the external apparatus, data representing a recognition execution determination result that indicates whether the information processing apparatus or the external apparatus should execute voice recognition processing of the voice data;
a voice synthesis step of, when the synthesis execution determination result indicates that the information processing apparatus should execute voice synthesis processing, generating output voice data to read aloud the document data received in the reception step;
a voice output step of reading aloud the document data received in the reception step using one of output voice data obtained by decoding the encoded output voice data received in the reception step and the output voice data generated in the voice synthesis step;
a voice recognition step of, when the recognition execution determination result indicates that the information processing apparatus should execute voice recognition processing, executing voice recognition for the voice data input in the input step; and
an encoded voice data transmission step of, when the recognition execution determination result indicates that the external apparatus should execute voice recognition processing, encoding the voice data input in the input step and transmitting the encoded voice data to the external apparatus.

22. A program which causes a computer to execute an information processing apparatus control method of claim 8.

23. A program which causes a computer to execute an information processing apparatus control method of claim 9.

24. A program which causes a computer to execute an information processing apparatus control method of claim 10.

25. A program which causes a computer to execute an information processing apparatus control method of claim 19.

26. A program which causes a computer to execute an information processing apparatus control method of claim 20.

27. A program which causes a computer to execute an information processing apparatus control method of claim 21.

28. A computer-readable storage medium which stores a program of claim 22.

29. A computer-readable storage medium which stores a program of claim 23.

30. A computer-readable storage medium which stores a program of claim 24.

31. A computer-readable storage medium which stores a program of claim 25.

32. A computer-readable storage medium which stores a program of claim 26.

33. A computer-readable storage medium which stores a program of claim 27.
